(19) United States
(12) Patent Application Publication
(10) Pub. No.: US 2022/0185833 A1
(43) Pub. Date: Jun. 16, 2022

(54) PROCESS FOR THE CARBONYLATION OF EPOXIDES

(71) Applicant: Covestro Deutschland AG, Leverkusen (DE)

(72) Inventors: Jens Langanke, Mechernich (DE); Christoph Guertler, Koln (DE); Matthias Leven, Koln (DE); Daniel Schikowski, Aachen (DE); Walter Leitner, Aachen (DE); Suresh Raju, Aachen (DE)

(21) Appl. No.: 17/540,601

(22) Filed: Dec. 2, 2021

(30) Foreign Application Priority Data
Dec. 15, 2020 (EP) 20214190.9

(51) Int. Cl. C07F 11/00; C07B 41/06; B01J 31/18; B01J 31/22; B01J 31/20

(52) U.S. Cl. CPC C07F 11/005; C07B 41/06; B01J 31/181; B01J 31/2217; B01J 2531/66; B01J 31/1815; B01J 2531/845; B01J 2531/62; B01J 31/20

(57) ABSTRACT

The invention relates to a process for the carbonylation of epoxides in the presence of catalyst systems, in which the carbonylation is carried out in the presence of carbon monoxide, and wherein the catalyst system comprises a vanadium-based, chromium-based, manganese-based and/or tungsten-based compound, preferably a tungsten-based compound. The invention further relates to carbonylation products and carbonylation conversion products and to the use of catalyst systems according to the invention for carbonylation of epoxides.

### CROSS REFERENCE TO RELATED APPLICATIONS

This application claims priority to European Patent Application No. 20214190.9 which was filed on Dec. 15, 2020, and which the contents thereof are hereby incorporated by reference into this specification.

### FIELD

The invention relates to a process for the carbonylation of epoxides in the presence of catalyst systems, in which the carbonylation is carried out in the presence of carbon monoxide, and wherein the catalyst system comprises a vanadium-based, chromium-based, manganese-based and/or tungsten-based compound, preferably a tungsten-based compound. The invention further relates to carbonylation products and carbonylation conversion products and to the use of catalyst systems according to the invention for carbonylation of epoxides.

### BACKGROUND

DE 10235316 A1 discloses a process for preparing lactones by catalytic carbonylation of oxiranes, in which a catalyst system is used composed of a) at least one carbonylation catalyst A composed of neutral or anionic transition metal complexes of metals from groups 5 to 11 of the Periodic Table of the Elements and b) at least one chiral Lewis acid B as catalyst, with the exception of [(salph)Al(THF)2][Co(CO)4].

WO 2006/058681 A2 describes a process for preparing enantiomerically enriched lactones by catalytic carbonylation of lactones to anhydrides in the presence of a neutral or anionic transition metal complex.

WO 2016/015019 A1 describes a process for preparing aluminium complexes, which are used to catalyze the carbonylation of epoxides.

JP2013173090 describes the carbonylation of epoxides using immobilized catalyst systems.

WO 2011/163309 A2 describes a two-stage process for producing polyhydroxybutyrate and/or polyhydroxypropionate homopolymers with subsequent thermal decomposition to form unsaturated acids such as crotonic acid and/or acrylic acid. In the first stage, epoxides are carbonylated to produce the corresponding beta-lactones and in the second stage converted to the corresponding homopolymers.

The US federal agency OSHA stipulates a time-weighted average occupational exposure limit of ≤0.1 ppm for cobalt carbonyls and cobalt hydrocarbonyls (cf. Clinical Toxicology, 1999, 37, 201-216), whereas average values for exposure limits for carbonyl compounds of the metals vanadium, chromium, manganese and tungsten are generally higher.

The global production of cobalt in 2016 was 123 000 tons (according to the Department of Natural Resources, Canada). In contrast, the annual global production of vanadium, chromium, manganese and tungsten is each in the order of millions of tons.

Starting from the prior art, the object of the present invention was to redress the disadvantages of cobalt-based catalysts for the carbonylation of epoxides.

### SUMMARY

The object of the present invention was therefore to provide a simplified process for the carbonylation of epoxides to form carbonylation products using a catalyst system, wherein in particular beta-lactones, cyclic ester ether compounds and, as conversion products thereof, polyhydroxyalkanoate (co)polymers, especially polyhydroxybutyrate and/or polyhydroxypropionate (co) polymers, should be provided by a direct and one-step process.

In this case, a chemically more stable catalyst system should be used, so that longer storage and/or technically simpler storage, handling and use compared to the cobalt-based systems described above from the prior art is possible. In the cobalt-based systems in the prior art described above, cobalt is in the very sensitive oxidation state of −1 and can be degraded exceptionally easily with oxidants of all kinds, as well as hydroxyl compounds or water. In addition, the catalyst systems according to the invention should be characterized by better industrial availability and lower toxicity compared to the cobalt-based systems, wherein direct further processing of the carbonylation products to carbonylation conversion products, for example conversion to polyurethanes, is also possible without prior removal of the catalyst system.

Surprisingly, it has been found that the object according to the invention is achieved by a process for the carbonylation of epoxides in the presence of catalyst systems, in which the carbonylation is carried out in the presence of carbon monoxide, characterized in that the catalyst system comprises a vanadium-based, chromium-based, manganese-based and/or tungsten-based compound, preferably a tungsten-based compound.

### BRIEF DESCRIPTION OF FIGURES

FIG. 1 shows a flow diagram illustrating the functionality of the program code used for the automated calculation of approximate activation energies.

FIG. 2 shows molecules of the starting compounds E1-3 and the simplified transition states T1-3. The corresponding dissociating chemical bonds which are kept constant are shown in bold.

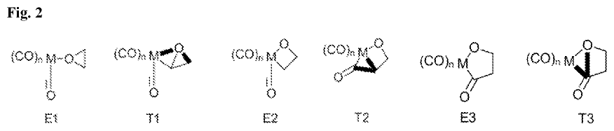

### DETAILED DESCRIPTION

In one embodiment of the process according to the invention, the vanadium-based, chromium-based, manganese-based and/or tungsten-based compound, preferably tungsten-based compound, is used in amounts of 0.0001 mol % to 20 mol %, based on the amount of epoxide.

In one embodiment of the process according to the invention, the vanadium in the vanadium-based compound has an oxidation state of minus one (−1), the chromium in the chromium-based compound has an oxidation state of zero (0), the manganese in the manganese-based compound has an oxidation state of zero (0) and plus one (+1) and/or the tungsten in the tungsten-based compound has an oxidation state of zero (0) and minus one (−1), preferably the tungsten in the tungsten-based compound has an oxidation state of zero (0) and minus one (−1).

In one embodiment of the process according to the invention, the vanadium-based, chromium-based, manganese-based and/or tungsten-based compound, preferably tungsten-based compound, is anionic.

In one embodiment of the process according to the invention, the vanadium-based, chromium-based, manganese-based and/or tungsten-based compound, preferably tungsten-based compound, comprises one or more carbonyl ligands, preferably one to six, particularly preferably two to five. In one embodiment of the process according to the invention, the vanadium-based, chromium-based, manganese-based and/or tungsten-based compound, preferably tungsten-based compound, has a further ligand (L) different from the carbonyl ligand, wherein the following functional relationship between the carbonyl ligand and the further ligands (L) of the monocyclic vanadium-based, chromium-based and tungsten-based compound and the bicyclic manganese-based compound results:

M(1)(CO)₆₋ₓLₓ

where M(1)=V, Cr, W, preferably W

M(2)₂(CO)₁₀₋ₓLₓ

where M(2)=Mn

In one embodiment of the process according to the invention, the ligand (L) is one or more compound(s) and is selected from the group consisting of hydrido, such as (H), halide such as F, Cl, Br and I, pseudohalide such as CN, N₃, OCN, NCO, CNO, SCN, NCS and SeCN, inorganic N ligands such as NC, NO, NO₂, NO₃, NH₂, NCH₃, NCCH₃ and NCCF₃, pseudochalcogenides, carboxylates such as OTf, OAc and HCOO, other inorganic anions such as OH and HSO₄, allyl compounds such as η³-C₃H₅, dienes such as butadienes (C₄C₆), cyclic C5 ligands such as cyclopentadienyl (Cp, η⁵-C₅H₅) and pentamethylcyclopentadienyl (Cp*, η⁵-C₅Me₅), alkyl compounds, aryl compounds, Fischer carbenes such as C(Ph)(Ph) (as Fischer carbene), C(OMe)(Ph) (as Fischer carbene), C(OEt)(NHPh) (as Fischer carbene), NHC carbenes such as 1,3-dimesitylimidazol-2-ylidene (IMes, NHC carbene) and 1,3-bis(2,4,6-trimethylphenyl)-4,5-dihydroimidazol-2-ylidene (SIMes, NHC carbene), amines such as NH₃, ethylenediamine (eda), diethylenetriamine, aniline, pyridine, 2,2′-bipyridine (bipy) and terpyridine, imines, aminophosphines such as PNP, PDI and PBP, phosphines such as PPh₃, PMe₃, PEt₃, PBu₃, PH₃, P(OMe)₃ and P(OEt)₃, phosphites, PEP pincer ligands where E=B and N, and ethers such as diethyl ether, THF and 2-Me-THF.

In a preferred embodiment of the process according to the invention, the ligand (L) is one or more compound(s) and is selected from the group consisting of H, F, Cl, Br, I, CN, NC, SCN, N₃, NO₂, NO₃, NH₂, OTf, OAc, OH, H₅O₄, η³-C₃H₅, butadiene (C₄C₆), cyclopentadienyl (Cp, η⁵-C₅H₅), pentamethylcyclopentadienyl (Cp*, η⁵-C₅Me₅), C(Ph)(Ph) (as Fischer carbene), C(OMe)(Ph) (as Fischer carbene), C(OEt)(NHPh) (as Fischer carbene), 1,3-dimesitylimidazol-2-ylidene (IMes, NHC carbene), 1,3-bis(2,4,6-trimethylphenyl)-4,5-dihydroimidazol-2-ylidene (SIMes, NHC carbene), NH₃, ethylenediamine (eda), diethylenetriamine, tetramethylethylene diamine, aniline, pyridine, 2,2′-bipyridine (bipy), PPh₃, PMe₃, PEt₃, PBu₃, PH₃, P(OMe)₃, P(OEt)₃, diethyl ether, THF and 2-Me-THF, preferably H, F, Cl, Br, I, CN, NC, SCN, N₃, NO₂, NO₃, NH₂, OTf, OAc, η³-C₃H₅, butadiene (C₄C₆), cyclopentadienyl (Cp, η⁵-C₅H₅), pentamethylcyclopentadienyl (Cp*, η⁵-C₅Me₅), C(Ph)(Ph) (as Fischer carbene), C(OMe)(Ph) (as Fischer carbene), C(OEt)(NHPh) (as Fischer carbene), 1,3-dimesitylimidazol-2-ylidene (IMes, NHC carbene), 1,3-bis(2,4,6-trimethylphenyl)-4,5-dihydroimidazol-2-ylidene (SIMes, NHC carbene), ethylenediamine (eda), diethylenetriamine, tetramethylethylenediamine, aniline, pyridine, 2,2′-bipyridine (bipy), PPh₃ and PMe₃, particularly preferably H, F, Cl, Br, I, CN, NC, SCN, N₃, OTf, cyclopentadienyl (Cp, η⁵-C₅H₅), pentamethylcyclopentadienyl (Cp*, η⁵-C₅Me₅), C(Ph)(Ph) (as Fischer carbene), C(OMe)(Ph) (as Fischer carbene), C(OEt)(NHPh) (as Fischer carbene), 1,3-dimesitylimidazol-2-ylidene (IMes, NHC carbene) and 1,3-bis(2,4,6-trimethylphenyl)-4,5-dihydroimidazol-2-ylidene (SIMes, NHC carbene), especially preferably Cl, Br, I, ethylenediamine (eda), 2,2′-bipyridine (bipy), cyclopentadienyl (Cp, η⁵-C₅H₅) and pentamethylcyclopentadienyl (Cp*, η⁵-C₅Me₅).

In one embodiment of the process according to the invention, the catalyst system comprises an additional Lewis acid.

Lewis acids comprise one or more coordinatively unsaturated metal atoms as the Lewis acidic centre, such as aluminium, tin, zinc, bismuth, vanadium, chromium, molybdenum, tungsten, iron, cobalt, nickel, rhodium, iridium, palladium, platinum, copper or zinc. However, the semi-metal boron also forms the Lewis acidic centre of Lewis acids. Coordinatively unsaturated Lewis acidic centres are characterized by the fact that nucleophilic molecules can bind to them. Coordinatively unsaturated Lewis-acidic centres may already be present in the compound used as catalyst or forms in the reaction mixture, for example as a result of elimination of a weakly bonded nucleophilic molecule.

In a further embodiment of the process according to the invention, the synthesis of the catalyst systems can also take place in the reaction mixture itself and/or under reaction conditions. This procedure is referred to as the in situ generation of a catalyst system.

In one embodiment of the process according to the invention, the Lewis acid is cationic or charge-neutral, preferably cationic.

In a preferred embodiment of the process according to the invention, the Lewis acid is cationic.

The Lewis acids may be simple inorganic, organometallic or organic compounds, such as BF₃, AlCl₃, FeCl₃, B(CH₃)₃, B(OH)₃, BPh₃, B(OR)₃, SiCl₄, SiF₄, PF₄, CO₂, SO₃ etc. and also adducts of these compounds. However, Lewis acids of more complex structure, in which the Lewis acidic centre is coordinated by complex ligands, are also known and are preferably used in an embodiment of the process according to the invention. In particular, the ligands have the role of having a stabilizing and/or reinforcing effect on the Lewis acidic centres through partial coordinative saturation of the Lewis acidic centre(s). A distinction can be made between electronic and steric effects of the ligand molecules. Square and tetrahedral coordination polyhedra between N and/or O ligand(s) and Lewis acidic centres are particularly suitable.

The catalyst system with cationic Lewis acid can be formally represented as follows:

[M′(CO)_{6-zx}L_{x,z}]^{l-}[ML′m]ⁿ⁺ₒ

where L′ is the same ligand of the Lewis acid and o is the number of Lewis acids of the total ion pair. In addition, the denticity of the ligands in the formula notation is specified by the index z, the number thereof by the index x.

In one embodiment of the process according to the invention, the cationic Lewis acid is an unsubstituted dicyclopentadienyl metal cation, a substituted dicyclopentadienyl metal cation, an unsubstituted metal porphyrin cation, a substituted metal porphyrin cation, an unsubstituted metal salen cation, a substituted metal salen cation, an unsubstituted metal salphen cation and/or a substituted metal salphen cation.

Particularly preferred as Lewis acids in one embodiment of the process according to the invention are cyclopentadienyl metal complexes, Lewis acids based on unsubstituted and substituted porphyrin, chlorin and corrin complexes, Lewis acids based on unsubstituted and substituted salen, salpn, salan, salalen, salph, salphen and salqu complexes, Lewis acids based on unsubstituted and substituted pincer complexes, Lewis acids based on unsubstituted and substituted pincer-diiminopyridine complexes.

Cyclopentadienyl metal complexes, which are complexes between one or more metals and one or more cyclopentadienyl derivative ligands (C₅R₅—), are characterized by the presence of so-called if metal-ligand bonds. In one embodiment of the process according to the invention, cyclopentadienyl metal complexes (Cp complexes), pentamethylcyclopentadienyl metal complexes (Cp* complexes), dicyclopentadienyl metal complexes ((Cp)2 complexes) and dipentamethylcyclopentadienyl metal complexes ((Cp*)2 complexes) are suitable as Lewis acids. In addition to these unsubstituted Cp rings and Cp* ring systems, all other conceivable substitution patterns are also possible. In one embodiment of the process according to the invention, the dicyclopentadienyl metal complex is [Cp₂Ti]⁺ and/or [Cp₂Ti(L′)₂]⁺ where L′=THF, Et₂O, PO and/or EO.

Lewis acids based on unsubstituted and substituted porphyrin, chlorin and corrin complexes with the Lewis acidic centre selected from the groups of aluminium, tin, zinc, bismuth, vanadium, chromium, molybdenum, manganese, tungsten, iron, cobalt, nickel, rhodium, iridium, indium, cerium, lanthanum, yttrium, gadolinium, palladium, platinum, copper and zinc. All conceivable substitution patterns are possible. In one embodiment of the process according to the invention, the substituents are each independently selected from the group consisting of hydrogen (—H), methyl, tert- butyl, methoxy, phenyl, 4-methylphenyl, 4-methoxyphenyl, 4-chlorophenyl, 4-bromophenyl, 4-carboxylphenyl, 3,5-dimethoxyphenyl, 2-pyridyl, 4-pyridyl and N-methyl-4-pyridyl, preferably tert-butyl, methoxy, phenyl, 4-methylphenyl, 4-methoxyphenyl, 4-chlorophenyl or 3,5-dimethoxyphenyl, especially preferably phenyl.

Lewis acids based on unsubstituted and substituted salen, salpn, salan, salalen, salph, salphen and salqu complexes with the Lewis acidic centre selected from the groups of aluminium, tin, zinc, bismuth, vanadium, chromium, molybdenum, manganese, tungsten, iron, cobalt, nickel, rhodium, iridium, indium, cerium, lanthanum, yttrium, gadolinium, palladium, platinum, copper and zinc. All conceivable substitution patterns are possible. In one embodiment of the process according to the invention, the substituents are each independently selected from the group consisting of hydrogen (—H), methyl, tert-butyl, phenyl, nitro, bromine, chlorine, hydroxyl, diethylamino and methoxy, preferably selected from the group of hydrogen (—H), methyl or tert-butyl, especially preferably tert-butyl.

Lewis acids based on unsubstituted and substituted pincer complexes with the Lewis acidic centre selected from the groups of aluminium, tin, zinc, bismuth, vanadium, chromium, molybdenum, manganese, tungsten, iron, cobalt, nickel, ruthenium, rhodium, iridium, indium, cerium, lanthanum, yttrium, gadolinium, palladium, platinum, copper and zinc. In one embodiment of the process according to the invention, the ligands of these pincer complexes have the general form A-(organic linker)-E-(organic linker)-A, where A is selected from the group of the elements P, N and S and where E is selected from the group of elements C, B and N, and are tridentate.

Lewis acids based on unsubstituted and substituted pincer-diiminopyridine complexes (abbreviation: DIP complexes) with the Lewis acidic centre selected from the groups of aluminium, tin, zinc, bismuth, vanadium, chromium, molybdenum, manganese, tungsten, iron, cobalt, nickel, ruthenium, rhodium, iridium, indium, cerium, lanthanum, yttrium, gadolinium, palladium, platinum, copper and zinc. In one embodiment of the process according to the invention, the ligands of these DIP complexes are in the form of diiminopyridine and derivatives thereof.

In one embodiment of the process according to the invention, the catalyst system has the structure (I), (II), (III), (IV), (V) and/or (VI):

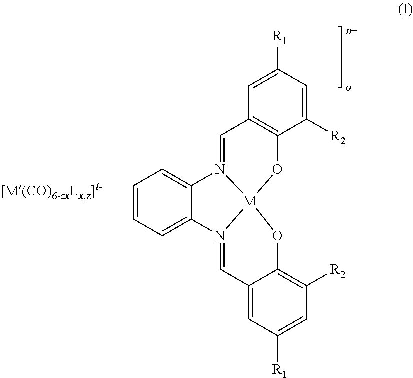

where L=H, F, Cl, Br, I, CN, NC, SCN, NCS, CP, N₃, NO₂, NO₃, NH₂, OTf, OH, HSO₄, eda or bipy, preferably H, F, Cl, Br, I, CN, N₃, OTf, eda or bipy, especially preferably Cl, Br, eda or bipy;
where M=Cr(III), Al(III), Fe(III), Co(III), Mn(III), V(III), In(III), Ga(III), Y(III), Ru(III), La(III), Ce(III), Gd(III) or Ir(III), preferably Cr(III), Al(III), Fe(III), Co(III), Mn(III) or Ga(III), especially preferably Cr(III) or Al(III);
where M′=V, Cr, Mn or W, preferably W;
where R₁ and R₂ are each independently selected from the group comprising hydrogen (—H), methyl, tert-butyl, phenyl, nitro, bromine, chlorine, hydroxyl, diethylamino and methoxy, preferably R₁ is identical to R₂, selected from the group of hydrogen (—H), methyl or tert-butyl, especially preferably tert-butyl;

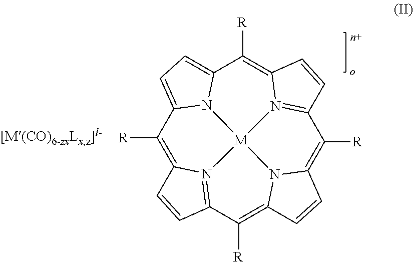

where L=H, F, Cl, Br, I, CN, NC, SCN, NCS, CP, N₃, NO₂, NO₃, NH₂, OTf, OH, HSO₄, eda or bipy, preferably H, F, Cl, Br, I, CN, N₃, OTf, eda or bipy, especially preferably Cl, Br, eda or bipy;
where M=Cr(III), Al(III), Fe(III), Co(III), Mn(III), V(III), In(III), Ga(III), Y(III), Ru(III), La(III), Ce(III), Gd(III) or Ir(III), preferably Cr(III), Al(III), Fe(III), Co(III), Mn(III) or Ga(III), especially preferably Cr(III) or Al(III);
where M′=V, Cr, Mn or W, preferably W;
where R is selected from the group comprising hydrogen (—H), methyl, tert-butyl, methoxy, phenyl, 4-methylphenyl, 4-methoxyphenyl, 4-chlorophenyl, 4-bromophenyl, 4-carboxylphenyl, 3,5-dimethoxyphenyl, 2-pyridyl, 4-pyridyl and N-methyl-4-pyridyl, preferably tert-butyl, methoxy, phenyl, 4-methylphenyl, 4-methoxyphenyl, 4-chlorophenyl or 3,5-dimethoxyphenyl, especially preferably phenyl.

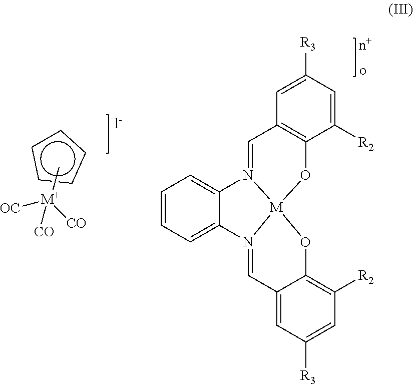

where M=Cr(III), Al(III), Fe(III), Co(III), Mn(III), V(III), In(III), Ga(III), Y(III), Ru(III), La(III), Ce(III), Gd(III) or Ir(III), preferably Cr(III), Al(III), Fe(III), Co(III), Mn(III) or Ga(III), especially preferably Cr(III) or Al(III);
where M′=V, Cr, Mn or W, preferably W;
where R₁ and R₂ are each independently selected from the group comprising hydrogen (—H), methyl, tert-butyl, phenyl, nitro, bromine, chlorine, hydroxyl, diethylamino and methoxy, preferably R₁ is identical to R₂, selected from the group of hydrogen (—H), methyl or tert-butyl, especially preferably tert-butyl;

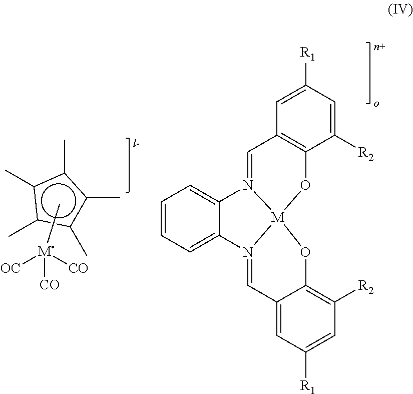

where M=Cr(III), Al(III), Fe(III), Co(III), Mn(III), V(III), In(III), Ga(III), Y(III), Ru(III),
La(III), Ce(III), Gd(III) or Ir(III), preferably Cr(III), Al(III), Fe(III), Co(III), Mn(III) or Ga(III), especially preferably Cr(III) or Al(III);
where M′=V, Cr, Mn or W, preferably W;
where R₁ and R₂ are each independently selected from the group comprising hydrogen (—H), methyl, tert-butyl, phenyl, nitro, bromine, chlorine, hydroxyl, diethylamino and methoxy, preferably R₁ is identical to R₂, selected from the group of hydrogen (—H), methyl or tert-butyl, especially preferably tert-butyl;

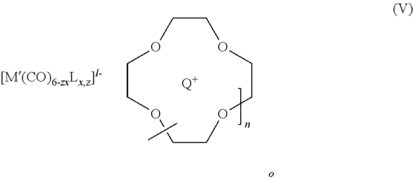

where L=H, F, Cl, Br, I, CN, NC, SCN, NCS, CP, N₃, NO₂, NO₃, NH₂, OTf, OH, HSO₄, eda or bipy, preferably H, F, Cl, Br, I, CN, N₃, OTf, eda or bipy, especially preferably Cl, Br, eda or bipy;
where Q=Li, Na, K, Rb, Cs, Cu or Ag, preferably Li, Na, K or Rb, especially preferably K;
where M′=V, Cr, Mn or W, preferably W;
where n=1-5, preferably 2-5, especially preferably 3; and/or

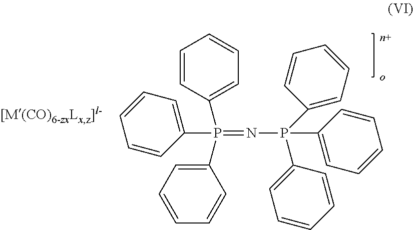

where L=H, F, Cl, Br, I, CN, NC, SCN, NCS, CP, N₃, NO₂, NO₃, NH₂, OTf, OH, HSO₄, eda or bipy, preferably H, F, Cl, Br, I, CN, N₃, OTf, eda or bipy, especially preferably Cl, Br, eda or bipy;
where M′=V, Cr, Mn or W, preferably W.

In a preferred embodiment of the process according to the invention, the catalyst system has the structure (VII), (VIII), (IX), (X), (XI), (XII), (XIII) and/or (XIV):

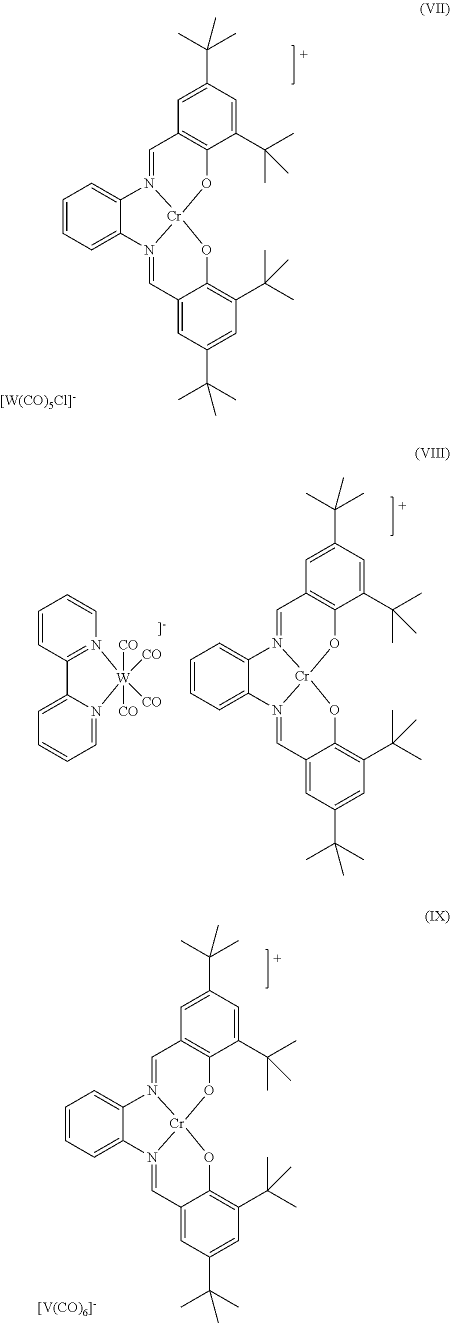

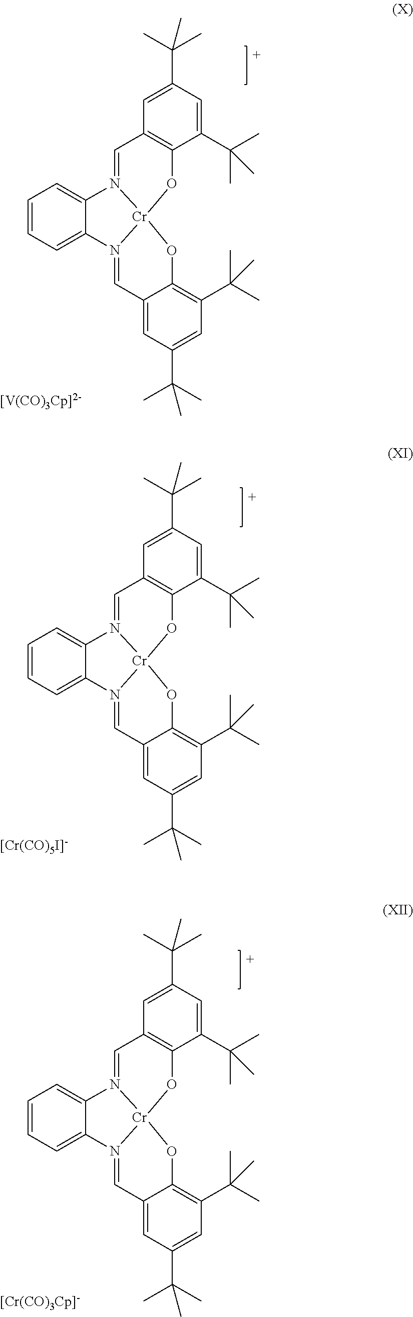

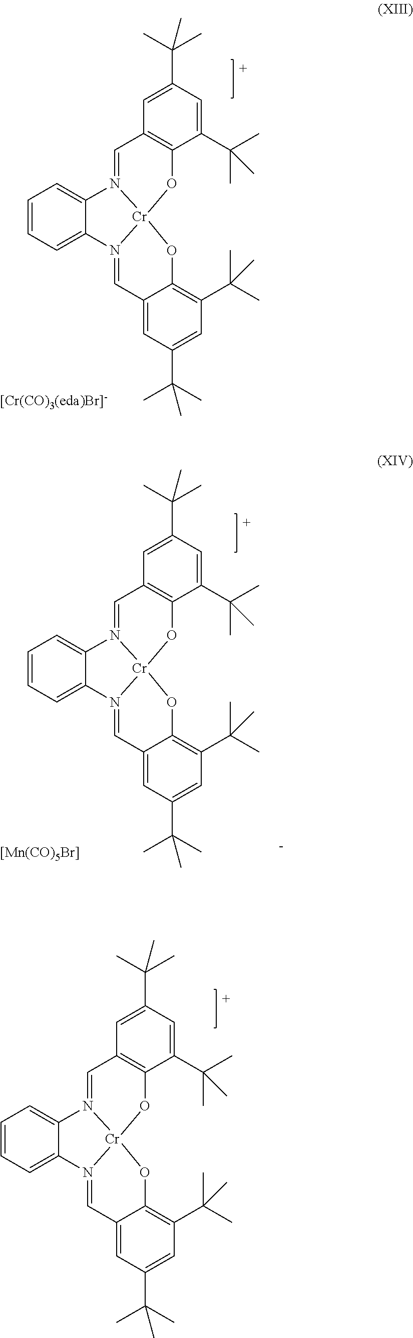

In a particularly preferred embodiment of the process according to the invention, the catalyst system has the structure (VII) and/or (VIII) and especially preferably the structure (VII).

The epoxide according to the invention may be an epoxide having 2-45 carbon atoms. In a preferred embodiment of the process, the epoxide is selected from at least one compound from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, epoxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, allyl glycidyl ether, vinylcyclohexene oxide, cyclooctadiene monoepoxide, cyclododecatriene monoepoxide, butadiene monoepoxide, isoprene monoepoxide, limonene oxide, 1,4-divinylbenzene monoepoxide, 1,3-divinylbenzene monoepoxide, glycidyl acrylate benzene oxide, naphthalene oxide and glycidyl methacrylate, mono- or polyepoxidized fats as mono-, di- and triglycerides, epoxidized fatty acids, C1-C24 esters of epoxidized fatty acids, epichlorohydrin, glycidol, and derivatives of glycidol, for example glycidyl ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether.

In a particularly preferred embodiment of the process, the epoxide is ethylene oxide and/or propylene oxide.

In one embodiment of the process according to the invention, the carbonylation process is carried out in the presence of a suspension medium, preferably an aprotic suspension medium.

The suspension media used according to the invention do not comprise any H-functional groups. Suitable suspension media include all polar aprotic, weakly polar aprotic and non-polar aprotic solvents, none of which contain any H-functional groups. Suspension media used may also be a mixture of two or more of these suspension media. Mention is made by way of example at this point of the following polar aprotic solvents: 4-methyl-2-oxo-1,3-dioxolane (hereinafter also referred to as cyclic propylene carbonate or cPC), 1,3-dioxolan-2-one (hereinafter also referred to as cyclic ethylene carbonate or cEC), methyl formate, ethyl formate, isopropyl formate, propyl formate, ethyl acetate, isopropyl acetate, n-butyl acetate, methyl oxalate, 2,2-dimethoxypropane, acetone, methyl ethyl ketone, acetonitrile, benzonitrile, diethyl carbonate, dimethyl carbonate, nitromethane, dimethyl sulfoxide, sulfolane, dimethylformamide, dimethylacetamide and N-methylpyrrolidone. The group of non-polar and weakly polar aprotic solvents includes, for example, ethers such as dioxolane, dioxane, diethyl ether, methyl tert-butyl ether, ethyl tert-butyl ether, tert-amyl methyl ether, butyl methyl ether, methyl propyl ether, dimethyl ether, diisopropyl ether, ethyl methyl ether, methyl phenyl ether, dimethoxymethane, diethoxymethane, dimethoxyethane (glyme), [12] crown-4, cyclopentyl methyl ether, triglyme, tetraglyme, diethylene glycol dibutyl ether, 2-methyltetrahydrofuran and tetrahydrofuran, esters such as ethyl acetate and butyl acetate, hydrocarbons such as pentane, n-hexane, benzene and alkylated benzene derivatives (e.g. toluene, xylene, ethylbenzene) and chlorinated hydrocarbons such as chloroform, chlorobenzene, dichlorobenzene, fluorobenzene, difluorobenzene, methylene chloride and carbon tetrachloride. Preferred suspension media used are 4-methyl-2-oxo-1,3-dioxolane, 1,3-dioxolan-2-one, 2-methyltetrahydrofuran, tetrahydrofuran, dioxanes, dimethoxyethane (glyme), diethyl ether, ethyl acetate, methyl ethyl ketone, N-methylpyrrolidone, acetonitrile, sulfolane, dimethyl sulfoxide, dimethylformamide, toluene, xylene, ethylbenzene, dichlorobenzene, fluorobenzene, chlorobenzene and difluorobenzene and mixtures of two or more of these suspension media, particular preference being given to 4-methyl-2-oxo-1,3-dioxolane, 1,3-dioxolan-2-one, 2-methyltetrahydrofuran, tetrahydrofuran, dimethoxyethane (glyme), diethyl ether, ethyl acetate, acetonitrile, toluene, dichlorobenzene, fluorobenzene, chlorobenzene and difluorobenzene and mixtures of two or more of these suspension media.

In one embodiment of the process according to the invention, the process is carried out at a CO partial pressure of 60 to 130 bara, preferably 70 to 120 bara and particularly preferably 100 to 120 bara.

In one embodiment of the process according to the invention, the process is carried out at temperatures of 0° C. to 200° C., preferably 60-190° C. and particularly preferably 80-180° C.

The present invention also relates to carbonylation products by reacting epoxides with carbon monoxide in accordance with the process according to the invention, in which the molar proportion of cyclic anhydrides, based on the epoxide used, is less than 5 mol %, wherein the proportion of cyclic anhydrides was determined by the ¹H-NMR method disclosed in the experimental section.

Carbonylation products are understood to mean reaction products of epoxides with carbon monoxide, such as 4-ring lactones, beta-butyrolactone as reaction product of propylene oxide and CO, and propiolactone as reaction product of ethylene oxide and CO, and polyhydroxyalkanoates as polymerization product of 4-ring lactones, in particular polyhydroxybutyrate from beta-butyrolactone and polyhydroxypropionate from propiolactone, and also copolymers thereof which also have polyether repeating units in addition to the polyester repeating units mentioned. According to the invention, carbonylation products also include reaction products of epoxides with carbon monoxide to give corresponding cyclic ester-ether compounds, in particular dioxepanone and dioxocanedione compounds, especially 1,4-dioxepan-5-one, 2,7-dimethyl-1,4-dioxepan-5-one, 2,6-dimethyl-1,4-dioxepan-5-one, 3,6-dimethyl-1,4-dioxepan-5-one, 3, 7-dimethyl-1,4-dioxepan-5-one, 1, 5-dioxocane-2,6-dione, 3,8-dimethyl-1,5-dioxocane-2,6-dione, 3,7-dimethyl-1,5-dioxocane-2,6-dione and 4,8-dimethyl-1,5-dioxocane-2,6-dione.

Here, polyhydroxybutyrate (abbreviation: PHB)—

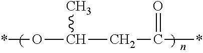

and/or polyhydroxypropionate (abbreviation: PHP)

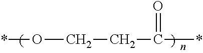

are present in the form of copolymers together with polyether repeating units,

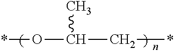

such as polyether repeating unit formed from PO and/or * [symbol] O—CH₂CH₂ [symbol] ₙ* polyether repeating unit formed from EO (*=end groups and/or other repeating units).

The present invention further relates to a process for producing carbonylation conversion products, preferably polyurethanes, by reacting the carbonylation products according to the invention with epoxides, polyisocyanates and/or polycarboxylic acids, preferably with poly isocyanates.

The present invention also relates to the use of the catalyst system comprising the vanadium-based, chromium-based, manganese-based and/or tungsten-based compound, preferably tungsten-based compound according to the invention for the carbonylation of epoxides.

### EXAMPLES

Starting Materials Used:

Argon, abbreviation Ar, 99.998%, Westfalen AG

Deuterated chloroform, CDCl₃, 99.8%, Eurisotop

Deuterated tetrahydrofuran, THF-d₈, 99.5%, Eurisotop

ARCOL® POLYOL 1004, abbreviation: PET 1004, Covestro Deutschland AG

beta-Butyrolactone, abbreviation: bBL, 98%, Sigma Aldrich Chemie GmbH

Toluene, dry, 99.85%, Acros Organics

Methanol, dry, 99.8%, Acros Organics

Trifluoromethanesulfonic acid, abbreviation: TfOH, 98%, Alfa Aesar

Silica gel 60, abbreviation: SiO₂, Sigma Aldrich Chemie GmbH

3,5-Di-tert-butylsalicyladehyde, Sigma Aldrich Chemie GmbH

Chromium(II) chloride, CrCl₂, dry, 99.9%, Strem Chemicals, Inc.

Tetrahydrofuran, abbreviation: THF, dry, 99.5%, Acros Organics

Celite® 545, abbreviation: Celite, Acros Organics

n-Pentane, abbreviation: pentane, dry, 99%, Acros Organics

Naphthalene, abbreviation: Nap, 99%, Sigma Aldrich Chemie GmbH

Carbon monoxide, abbreviation: CO, 99.9%, Paxair Germany GmbH

Propylene oxide, abbreviation: PO, 99.5%, Sigma Aldrich Chemie GmbH

Dimethoxyethane, abbreviation: DME, dry, 99.5%, Acros Organics

Molecular sieve 3 Å, dried, Sigma Aldrich Chemie GmbH

Potassium graphite, KCB, Strem Chemicals Inc.

Tungsten hexacarbonyl, W(CO)₆, 97%, Sigma Aldrich Chemie GmbH

Sodium hydroxide, NaOH, Honeywell

Dicobalt octacarbonyl, Co₂(CO)₈, ≥90% (1-10% hexane), Sigma Aldrich Chemie GmbH

All liquids were degassed by multiple freeze-pump-thaw cycles and stored under an Ar protective gas atmosphere. Solids were degassed under reduced pressure and also stored under an Ar protective gas atmosphere. Propylene oxide was degassed by multiple freeze-pump-thaw cycles and stored at 0° C. under an Ar protective gas atmosphere and over 3 Å molecular sieves. Naphthalene was sublimed and stored in a glove box under reduced pressure.

IR Analysis:

All IR measurements were carried out on a Bruker Alpha-PFT-IR spectrometer. If necessary, the measurements were carried out under Ar protective gas. An automatic baseline correction was applied for all measured spectra. For further details on the IR analysis of the product mixtures, see “Quantitative IR analysis” below.

NMR Analysis:

NMR spectra were recorded on a Bruker AV400 or AV300 spectrometer at room temperature. 1H-NMRs were measured at 400 or 300 MHz, 13C-NMRs correspondingly at 100 or 75 MHz. The 1H and 13C NMR signals are referenced to CHCl3 and TMS respectively.

Quantitative IR Analysis:

To calibrate the quantitative IR, mixtures of polyhydroxybutyrate and polyether with 0-25% by weight polyhydroxybutyrate fraction were prepared and measured. The calibration line results from plotting the relative absorbance against the relative fraction by weight of polyhydroxybutyrate. The relative absorbance is determined from the ratio of the absorbance of the C═O band to that of the C—O band. The relative proportion by mass (in wt %) of polyhydroxybutyrate repeating units to polyether repeating units—in non-volatile reaction residues (cf. general test procedure)—was therefore calculated as follows: w(polyhydroxybutyrate)=relative absorbance/0.0145. The procedure for polyhydroxypropionate was analogous. The relative proportion by mass (in wt %) of polyhydroxypropionate repeating units to polyether repeating units—in non-volatile reaction residues (cf. general test procedure)—was therefore calculated as follows: w(polyhydroxypropionate)=relative absorbance/0.053.

Polyether (Abbreviation PET 1004) as Reference Polymer:

ARCOL® POLYOL 1004 (PET 1004 for short) from Covestro was used as polyether reference polymer for quantitative IR and NMR analysis. This is a bifunctional polyether polyol based on PO having an average MW of ca. 435 g/mol.

IR: v=1087 (C—O) cm⁻¹.

¹H-NMR (CDCl₃, 7.26 ppm): 1.07-1.16 (m, CH₃), 3.14-3.92 (m, CH, CH₂);

¹³C-NMR (CDCl₃, 77.16 ppm): 17.0-18.6, 65.7-67.3, 73.4-76.1 ppm

Synthesis of Polyhydroxybutyrate (Abbreviation PHB):

Polyhydroxybutyrate (PHB for short) as reference polymer for quantitative IR and NMR analysis is synthesized in accordance with Tetrahedron Asymmetry, 2003, 14, 3249-3252 or Polym. Chem., 2014, 5, 161-168. Under an Ar protective gas atmosphere, 3.8 mL of β-butyrolactone and 40 mL of toluene were initially charged in a Schlenk flask, 0.07 mL each of methanol and trifluoromethanesulfonic acid were added and the mixture was then stirred at 30° C. for 2 hours. It was then quenched with 0.15 mL of diisopropylethylamine, concentrated on a rotary evaporator, purified by column chromatography (stationary phase: SiO₂, eluent: DCM/MeOH 20:1 v/v) and freed from solvent. The PHB reference polymer was finally dried in a high vacuum and analyzed by means of IR and NMR.

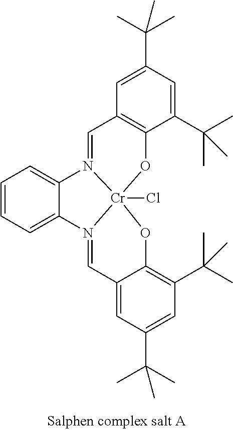

IR: v=1731 (C═O) cm⁻¹.

¹H-NMR (CDCl₃, 7.26 ppm): 5.25 (s, CH), 3.67 (s, OCH₃) 2.4-2.63 (d, CH₂), 1.25-1.28 (d, CH₃) ppm.

¹³C-NMR (CDCl₃, 77.16 ppm): 20.0 (CH₃), 41.0 (CH₂), 67.8 (CH), 169.4 (C═O) ppm.

Synthesis of the Salphen Complex Salt A:

The salphen complex salt A was synthesized according to Jiang et al. in Top. Catal., 2017, 60, 750-754 and an isolated yield of 77% was obtained.

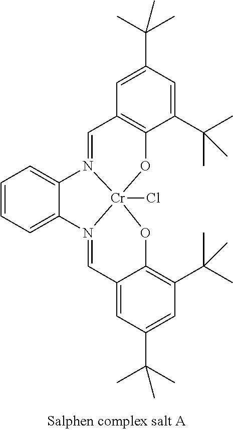

Synthesis of Catalyst System 1 of the Formula (VII):

To the solid mixture of W(CO)₆ (0.26 g, 0.75 mmol) and salphen complex salt A (0.47 g, 0.75 mmol) in a Schlenk flask was added THF (20 ml) under an Ar atmosphere. The reaction mixture was heated for 64 h under reflux. The flask was then cooled to RT. The reaction mixture obtained was transferred with the aid of a glass fibre filter cannula in order to remove insoluble materials. The solvent was then removed under reduced pressure, washed with hexane (2×15 mL) and subsequently dried under reduced pressure. This gave catalyst system 1 (0.43 g, 0.40 mmol, 53%). FT-IR (ATR under air atmosphere):2041, 1929, 1867 (C═O) cm⁻¹

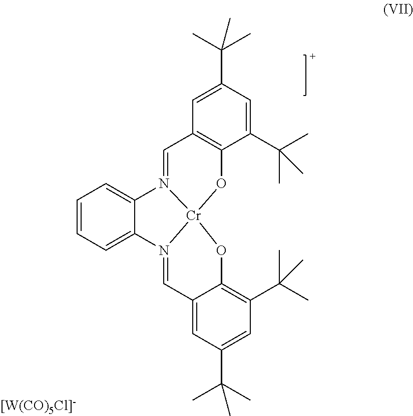

Synthesis of Catalyst System 2 of the Formula (VIII):

Catalyst system 2 was synthesized in accordance with the literature. In this case, a mixture of W(CO)₆ and 2,2′-bipyridine was refluxed in toluene. The solid product (0.2 g, 0.44 mmol) and KC8 (0.08 g, 0.59 mmol) were reacted in a Schlenk flask under an Ar atmosphere at −40° C. in THF (150 mL). The resulting reaction mixture was warmed to RT and stirred for 1 hour. Salphen complex salt A (0.28 g, 0.44 mmol) was then added at RT and the mixture was further stirred for 17 hours. After the reaction, the solvent was removed, washed with pentane and extracted with THF. The solution was filtered through Celite. The solvent was then removed under reduced pressure, which resulted in catalyst system 2 as a red-brown solid (0.28 g, 0.24 mmol, 54%). FT-IR (ATR under Ar atmosphere): 2003, 1861, 1805 (C═O) cm⁻¹

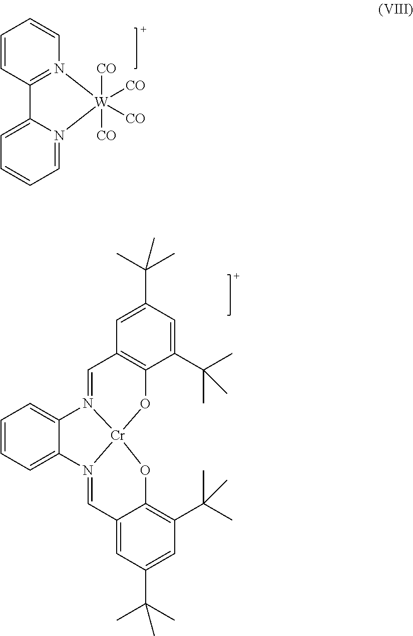

Synthesis of Catalyst System 3 of the Formula (XV) (Comparative):

The catalyst system 3 was synthesized according to Kramer et al. in Org. Lett., 2006, 8, 3709-3712 and an isolated yield of 68% was obtained.

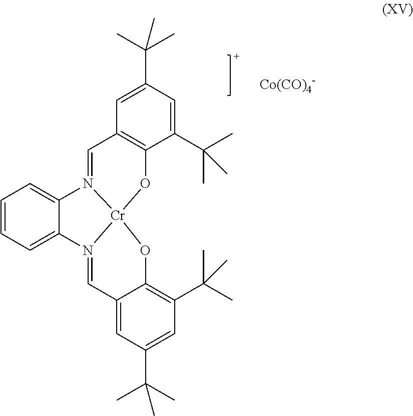

General Experimental Procedure:

The catalyst system, suspension medium, naphthalene as internal standard and epoxide were weighed into a Schlenk tube and stirred under a countercurrent of Ar protective gas. The total volume of the mixture was 2-5 mL. This mixture was then completely transferred to a 10 mL pressure reactor under a gentle CO gas countercurrent. The desired CO pre-pressure was adjusted while stirring, heated to reaction temperature and the initial pressure at the reaction temperature was determined. At the end of the reaction time, the final pressure at reaction temperature was determined and the pressure reactor was then cooled with the aid of a water/ice mixture. The remaining residual pressure was slowly released and a sample of the reaction mixture was immediately taken for analysis. After filtration through a short path column with celite as the stationary phase, part of the sample was analyzed by means of NMR and GC. Another part of the sample was freed from volatile constituents under reduced pressure and analyzed by quantitative IR and NMR. The polymer yield was determined gravimetrically, taking into account the remaining catalyst. The volatile constituents were collected with the aid of a cold trap, naphthalene was added as external standard and the mixture was also analyzed.

### Example 1: Carbonylation of Propylene Oxide Using Catalyst System 1

The experiment was carried out as described in the general experimental procedure. 1 mol % of catalyst system 1, DME as suspension medium, naphthalene as internal standard (0.009 mmol) and PO (0.924 mmol, 0.9M) were used. The reaction was carried out at 150° C., an initial pressure of 80 bar and a reaction time of 19 hours. A PO conversion of 95% was determined in the reaction mixture by NMR. The non-volatile constituents of the reaction mixture were isolated and analyzed. A content of 5.5% by weight PHB in the polymeric product was determined.

### Example 2: Carbonylation of Propylene Oxide Using Catalyst System 2

The experiment was carried out as described in the general experimental procedure. 1 mol % of catalyst system 2, THF as suspension medium, naphthalene as internal standard (0.009 mmol) and PO (0.924 mmol, 0.9M) were used. The reaction was carried out at 150° C., an initial pressure of 112 bar and a reaction time of 24 hours. A PO conversion of 64% was determined in the reaction mixture by NMR. The non-volatile constituents of the reaction mixture were isolated and analyzed. A polymer yield of 24% was determined with a proportion of 33.3% by weight PHB in the polymeric product.

### Example 3 (Comparative): Carbonylation of Propylene Oxide Using Catalyst System 3

The experiment was carried out as described in the general experimental procedure. 1 mol % of catalyst system 3, THF, naphthalene as internal standard (0.2 mmol) and PO (2 mmol, 0.9M) were used. The reaction was carried out at 120° C., an initial pressure of 82 bar and a reaction time of 15 hours. A PO conversion of 100%, the formation of 77% methylsuccinic anhydride and 2% acetone could be detected in the reaction mixture by NMR. Only traces of polymer and no PHB could be detected.

The characterization and quantification of methylsuccinic anhydride is based on the specific ¹H-NMR signals and their integrals in relation to the PO/internal standard used:

¹H-NMR (CDCl₃, 7.26 ppm): 1.42 (d, CH₃), 2.57-2.67 (m, CH), 3.11-3.23 (m, CH₂);

¹³C-NMR (CDCl₃, 77.16 ppm): 16.1, 35.7, 36.1, 170.1, 174.6

To find suitable metal carbonyl complexes which catalyze the insertion of carbon monoxide into epoxide compounds to form carbonylation products, the computer-aided simulation method described below was used.

Activation energies, which are critical for kinetic control of chemical reactions, can be calculated approximately by using quantum chemical simulations. As a result, quantum chemical simulations can be used supportively in order to develop novel catalyst systems for certain chemical reactions. For this purpose, the starting compounds of a catalyzed chemical reaction, and the rate-determining transition states are calculated using a suitable quantum chemical method and the activation energies resulting therefrom are determined by subtraction of the energy values thus obtained. In particular, since the calculation of the required transition states using established quantum chemical methods, such as the so-called Newton Raphson formalisms, can be very laborious and cannot be applied efficiently to large data sets, a method was developed and applied for this purpose which allows large data sets to be calculated using simplified estimates.

For this purpose, the quantum chemical calculations for the appropriate starting compounds and transition states of a single catalyst system was calculated with the aid of the steepest descent or pseudo-Newton Raphson formalism known from the prior art and was used as geometric template for other catalyst systems. Here, the resulting molecular geometries of the calculated transition states were examined for dissociating bonds (see Table 1) and these were saved for further definitions. In addition, a table was compiled which encompassed the chemical elements of the catalyst system to be investigated. Furthermore, a program code was used which employed the estimates of the required activation energies for catalyst systems to be investigated. This program code replaced the chemical elements to be varied in the starting compounds of the chemical reaction previously calculated and carried out a new quantum chemical calculation with the chemical elements thus replaced. In the second step, the chemical elements to be replaced in the transition state geometries previously calculated were replaced and a new calculation of the transition state geometries was carried out. For this purpose, however, instead of a Newton Raphson-based method for calculating transition states, which often results in failed attempts to localize transition states, a simplified calculation was carried out under the boundary condition that the saved dissociating chemical bonds were kept constant in length. This approximate method for calculating transition states, which was used here, has the advantage compared to the Newton Raphson formalism that no failed attempts to localize transition states can occur and the computational effort is considerably reduced. In addition, this simplification is significantly easier to automate. After obtaining the results of both procedures, the energies of the simplified transition states thus obtained were subtracted from those of the calculated starting compounds of the same chemical elements, in order to obtain the approximate activation energies for each catalyst system. A density functional theoretical method served as energy function for all calculations.

The selection of the dissociating bonds for executing the program code used is based on quantum chemically calculated transition states using the values specified in Table 1 for the chemical bonds in the dissociating range.

TABLE 1
Values for selecting dissociating chemical bonds in
quantum chemically calculated transition states.

| Bonds between atoms in | |
|---|---|
| the dissociating range | |
| of the period | Distance [pm] |
| 2-2 | 160-220 |
| 2-3 | 200-260 |
| 2-4 | 210-270 |
| 2-5 | 230-290 |
| 2-6 | 230-290 |

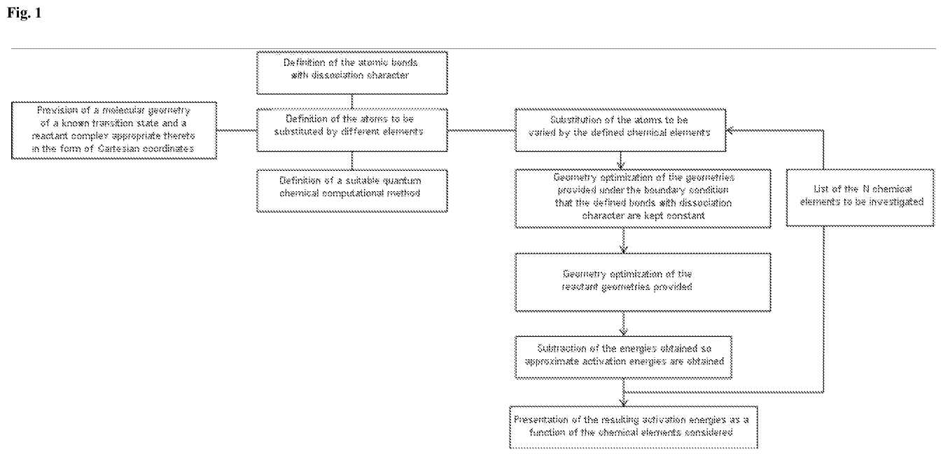

For this purpose, the starting compounds E1-3 and the transition states T1-3 were initially calculated for the element cobalt where n=4 carbon monoxide ligands with the aid of quantum chemical methods known generally from the prior art and the dissociating chemical bonds were identified between the atoms in T1-3 based on Table 1. In this case, bonds were only selected which have to be logically formed or removed from E to T. In this case, by way of example, bonds between metals and carbon monoxide ligands not involved in the chemical reaction were not considered. The dissociating chemical bonds thus selected were then saved for implementing the program code shown in FIG. 1. For the determination of further catalytically active metal carbonyls, the other elements tungsten, vanadium, manganese, chromium, osmium and copper were selected and the program codes presented in FIG. 1 implemented therewith.

The results resulting therefrom for the simplified activation energies are summarized in Table 2.

TABLE 2
Results of the simplified activation energies E(E-T) of the program code employed.

| M [Element | Oxidation state of | | E(T1-E1) | E(T2-E2) | E(T3-E3) |
|---|---|---|---|---|---|
| symbol] | M (catalyst used) | n(CO) | [kcal/mol] | [kcal/mol] | [kcal/mol] |
| (C) | (I) | 4 | 12.6 | 2.2 | 13.1 |
| W | 0 | 4 | 15.6 | 18.4 | 10.6 |
| Mn | 0 | 4 | 18.9 | 14.5 | 12.7 |
| Cr | 0 | 4 | 17.1 | 19.1 | 2.7 |
| Mo | 0 | 4 | 19.2 | 14.1 | 7.0 |
| Os | 0 | 4 | 25.0 | 37.0 | 28.5 |
| Cu | 0 | 4 | 27.3 | 4.3 | 6.0 |

The results of these computational chemical experiments show that metal carbonyl complexes of the metals vanadium, tungsten, manganese, chromium and molybdenum with the central atom in the oxidation states specified effectively catalyze the carbonylation of epoxides whereas the metals osmium and copper exhibit distinctly higher simplified activation energies and are therefore unsuitable as catalysts for this carbonylation chemistry.

The quantum chemical calculations of the molecule templates E1-3 and T1-3 and the implementation of the program code used were carried out using the following computational chemistry methodology: All quantum mechanical calculations were carried out using the software package TURBOMOLE version 7.3 from Cosmologic GmbH & Co. KG. The density functional theory method used was the BP86 density functional, implemented as unrestricted DFT for spin contamination of open-shell systems, with a def2-SVP basis set, as implemented as standard in the Turbomole software package. Transition states were geometry-optimized by means of standard implemented quasi Newton-Raphson algorithm (Powell update for Hessian matrix) and verified by analytical frequency calculations. Geometry optimizations with defined constant bond lengths as boundary condition were implemented using the “define” options under “idef” of the TURBOMOLE dialogue.

The computational chemistry methods described here can also be used for developing other catalyst systems in the same manner using corresponding definitions of the underlying reaction steps. These include, for example, catalyst systems which are used in hydrogenations, hydroformylations, carbonylation, oxidations, especially epoxidations and selective partial oxidations, (co)polymerizations, oligomerizations, cyclooligomerizations, dimerizations, coupling and cross-coupling reactions, hydrosilylations, hydroborations, hydrovinylations, C—H activations, nitrations, phosgenations, metatheses, isomerizations, especially alkene isomerizations, aminations, hydroaminations, dihydroxylations, click reactions, water-gas shift reactions, cycloadditions and reactions with CO2. In particular, these include catalyst systems which catalyze reaction of isocyanates with alcohols, the reactions of urethanes or other isocyanates, the polymerization of epoxides, especially the addition of epoxides onto an H-functional starter compound, specifically using ethylene oxide and/or propylene oxide, the reaction of uretdiones with alcohols, the functionalization of double bonds, carbon dioxide fixation in compounds that may be used industrially, such as polycarbonates, polyether polycarbonates, cyclic carbonates and conversion products of reductive CO2 conversions, the nitration of aromatics, the reduction of nitroaromatics, the production of chlorine, the formation of phosgene from CO and chlorine, the phosgenations of alcohols and amines, the epoxidation of olefins and other unsaturated compounds such as ethylene and propylene to form ethylene oxide and propylene oxide, the depolymerization of polycarbonates, polyurethanes, polyisocyanurates, polyureas, polyamides, polyaramids or aramids, polyesters, polyacrylates, polyoxazolidinones, polyethers, polyhydroxyalkanoates such as polyhydroxybutyrate and polyhydroxypropionate, oligo- and poly sugars, starches, cellulose, hemicellulose, chitin, lignin, humins and humic acids, silicones, polyolefins, polyvinyl chlorides, polystyrenes, polyacrylonitriles, polyether ketones, melamine resins, phenol resins, polyoxymethylene compounds such as POM-(co)polymers and paraformaldehyde-(co)polymers, proteins and the like, the reutilization of plastics and plastic degradation products and the production of base chemicals such as CO, ethylene, propylene, butadiene, benzene, toluene, xylene, methanol and formaldehyde.

These catalyst systems may also be used in the field of photocatalysis and electrocatalysis.

Using these computational chemistry methods, it is also possible to predict, and thus develop predictive computer-based mode of action of inhibitor molecules such as stabilizers for monomers and plastics, flame retardant additives, antioxidants, UV adsorbers, heat stabilizers, UV quenchers, HALS, sterically hindered phenols, scavenger molecules for degradation products and by-products in plastics and mixtures of substances, passivators and phlegmatizers for reactive substance mixtures and the like.

1. A process for a carbonylation of epoxides in the presence of a catalyst system, wherein the carbonylation is carried out in the presence of carbon monoxide, and wherein the catalyst system comprises a vanadium-based, chromium-based, manganese-based and/or tungsten-based compound.

2. The process according to claim 1, wherein the vanadium-based, chromium-based, manganese-based and/or tungsten-based compound comprises one or more carbonyl ligands.

3. The process according to claim 2, wherein the vanadium-based, chromium-based, manganese-based and/or tungsten-based compound comprises a further ligand L different from the carbonyl ligand.

4. The process according to claim 3, wherein the ligand L is one or more compounds selected from the group consisting of H, F, Cl, Br, I, CN, NC, SCN, N₃, NO₂, NO₃, NH₂, OTf, OAc, OH, HSO₄, η³-C₃H₅, butadiene, cyclopentadienyl (Cp), pentamethylcyclopentadienyl (Cp*), C(Ph)(Ph), C(OMe)(Ph), C(OEt)(NHPh), 1,3-dimesitylimidazol-2-ylidene, 1,3-bis(2,4,6-trimethylphenyl)-4,5-dihydroimidazol-2-ylidene, NH₃, ethylenediamine, diethylenetriamine, tetramethylethylene diamine, aniline, pyridine, 2,2′-bipyridine, PPh₃, PMe₃, PEt₃, PBu₃, PH₃, P(OMe)₃, P(OEt)₃, diethyl ether, THF and 2-Me-THF.

5. The process according to claim 1, wherein the catalyst system comprises an additional Lewis acid.

6. The process according to claim 5, wherein the Lewis acid is cationic or charge-neutral.

7. The process according to claim 6, wherein the Lewis acid is cationic.

8. The process according to claim 7, wherein the cationic Lewis acid is an unsubstituted dicyclopentadienyl metal cation, a substituted dicyclopentadienyl metal cation, an unsubstituted metal porphyrin cation, a substituted metal porphyrin cation, an unsubstituted metal salen cation, a substituted metal salen cation, an unsubstituted metal salphen cation and/or a substituted metal salphen cation.

9. The process according to claim 1, wherein the vanadium-based, chromium-based, manganese-based and/or tungsten-based compound is anionic.

10. The process according to claim 1, wherein the catalyst system has a structure (I), (II), (III), (IV), (V) and/or (VI): 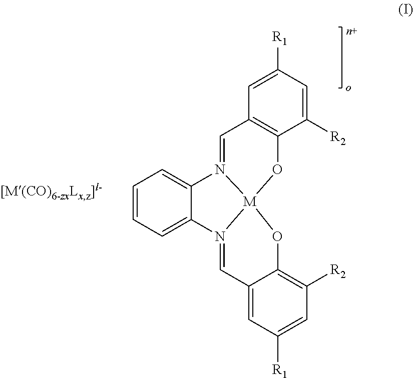
where L=H, F, Cl, Br, I, CN, NC, SCN, NCS, Cp, N₃, NO₂, NO₃, NH₂, OTf, OH, HSO₄, eda or bipy;
where M=Cr(III), Al(III), Fe(III), Co(III), Mn(III), V(III), In(III), Ga(III), Y(III), Ru(III), La(III), Ce(III), Gd(III) or Ir(III);
where M′=V, Cr, Mn or W;
where R₁ and R₂ are each independently selected from the group comprising hydrogen, methyl, tert-butyl, phenyl, nitro, bromine, chlorine, hydroxyl, diethylamino and methoxy; 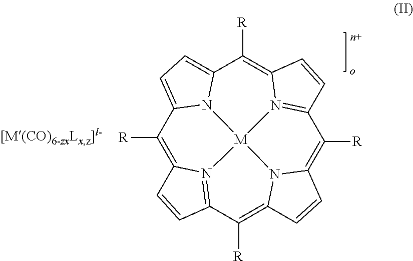
where L=H, F, Cl, Br, I, CN, NC, SCN, NCS, CP, N₃, NO₂, NO₃, NH₂, OTf, OH, HSO₄, eda or bipy;
where M=Cr(III), Al(III), Fe(III), Co(III), Mn(III), V(III), In(III), Ga(III), Y(III), Ru(III), La(III), Ce(III), Gd(III) or Ir(III);
where M′=V, Cr, Mn or W;
where R is selected from the group comprising hydrogen, methyl, tert-butyl, methoxy, phenyl, 4-methylphenyl, 4-methoxyphenyl, 4-chlorophenyl, 4-bromophenyl, 4-carboxylphenyl, 3,5-dimethoxyphenyl, 2-pyridyl, 4-pyridyl and N-methyl-4-pyridyl; 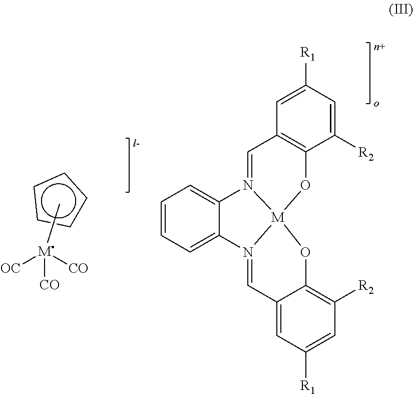
where M=Cr(III), Al(III), Fe(III), Co(III), Mn(III), V(III), In(III), Ga(III), Y(III), Ru(III), La(III), Ce(III), Gd(III) or Ir(III);
where M′=V, Cr, Mn or W;
where R₁ and R₂ are each independently selected from the group comprising hydrogen, methyl, tert-butyl, phenyl, nitro, bromine, chlorine, hydroxyl, diethylamino and methoxy; 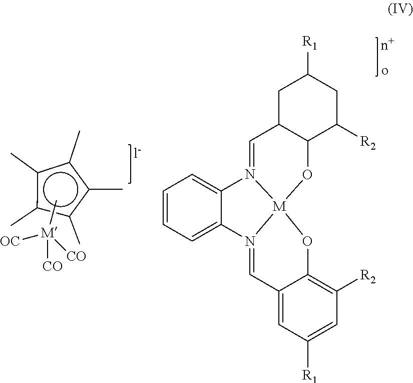
where M=Cr(III), Al(III), Fe(III), Co(III), Mn(III), V(III), In(III), Ga(III), Y(III), Ru(III), La(III), Ce(III), Gd(III) or Ir(III);
where M′=V, Cr, Mn or W;
where R₁ and R₂ are each independently selected from the group comprising hydrogen (—H), methyl, tert-butyl, phenyl, nitro, bromine, chlorine, hydroxyl, diethylamino and methoxy; 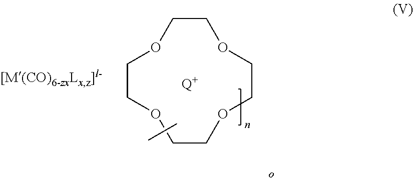
where L=H, F, Cl, Br, I, CN, NC, SCN, NCS, CP, N₃, NO₂, NO₃, NH₂, OTf, OH, HSO₄, eda or bipy;
where Q=Li, Na, K, Rb, Cs, Cu or Ag;
where M′=V, Cr, Mn or W;
where n=1-5;
and/or 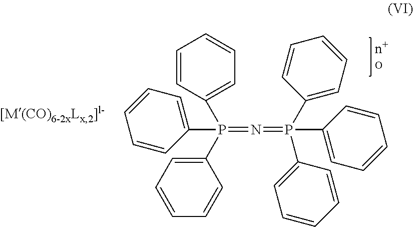
where L=H, F, Cl, Br, I, CN, NC, SCN, NCS, CP, N₃, NO₂, NO₃, NH₂, OTf, OH, HSO₄, eda or bipy;
where M′=V, Cr, Mn or W.

11. The process according to claim 1, wherein the catalyst system has a structure (VII), (VIII), (IX), (X), (XI), (XII), (XIII) and/or (XIV):

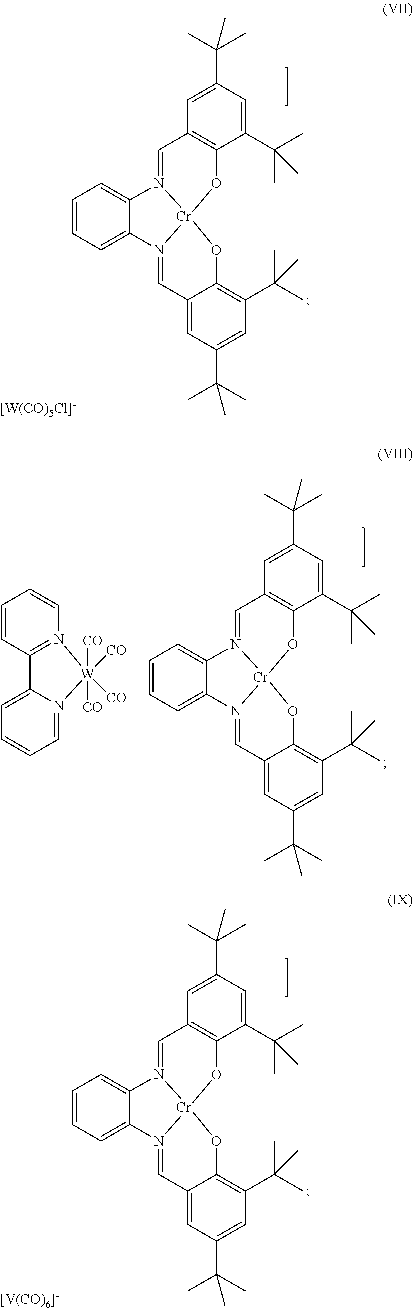

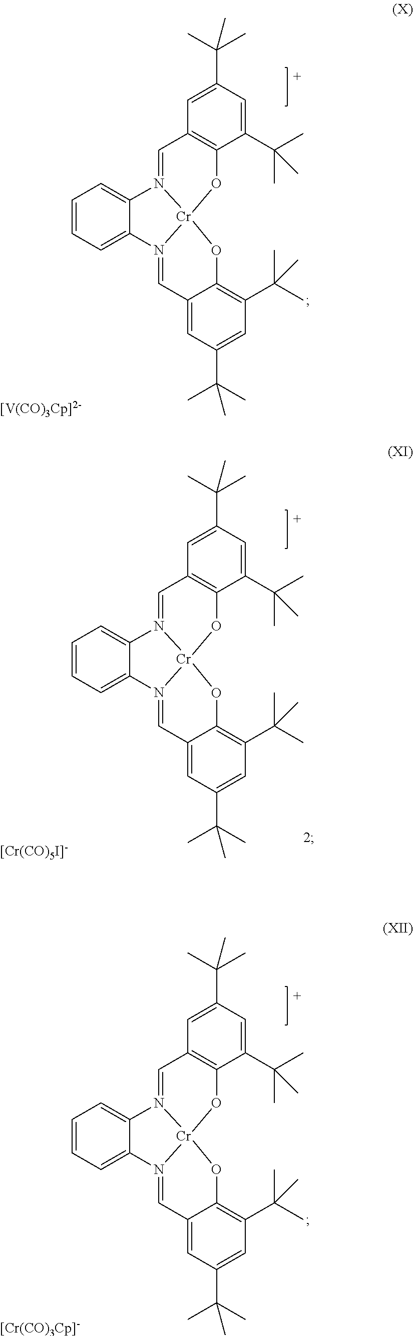

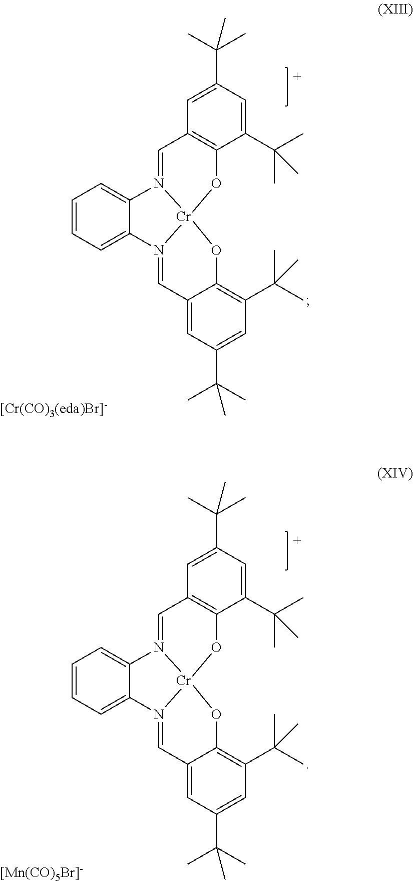

12. The process according to claim 11, wherein the catalyst system has the structure (VII) and/or (VIII).

13. Carbonylation products obtained by a process according to claim 1, wherein a molar proportion of cyclic anhydrides present in the carbonylation products, based on the epoxide used, is less than 5 mol %, wherein the proportion of cyclic anhydrides was determined by ¹H-NMR.

14. A process for producing carbonylation conversion products wherein the process comprises reacting the carbonylation products according to claim 13 with epoxides, polyisocyanates and/or polycarboxylic acids.

15. A method comprising a carbonylation of epoxides with of the catalyst system comprising the chromium-based, manganese-based and/or tungsten-based compound according to claim 1.

16. The process according to claim 1, wherein the catalyst system comprises a tungsten-based compound.

17. The process according to claim 2, wherein the vanadium-based, chromium-based, manganese-based and/or tungsten-based compound comprises two to five carbonyl ligands.

18. The process according to claim 2, wherein the tungsten-based compound comprises one or more carbonyl ligands.

19. The process according to claim 3, wherein the tungsten-based compound comprises a further ligand L different from the carbonyl ligand.

20. The process according to claim 4, wherein the ligand L is one or more compounds selected from the group consisting of Cl, Br, I, eda, bipy, Cp and Cp*.
